(19) United States
(12) Patent Application Publication
(10) Pub. No.: US 2008/0072212 A1
(43) Pub. Date: Mar. 20, 2008

(54) Semiconductor integrated circuit including a monitor unit

(75) Inventor: Shigeyuki Ueno, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/898,537

(22) Filed: Sep. 13, 2007

(30) Foreign Application Priority Data
Sep. 15, 2006 (JP) 2006-250486

(51) Int. Cl. G06F 9/44

(52) U.S. Cl. 717/126

(57) ABSTRACT

A semiconductor integrated circuit has a CPU executing a target program to be debugged, a peripheral circuit generating an internal signal in response to an operation of the CPU, and a monitor unit storing the internal signal of the peripheral circuit in response to a first status signal from the CPU executing the target program.

### BACKGROUND OF THE INVENTION

1. Field of the Invention

The present invention relates to a semiconductor integrated circuit, and more particularly, a semiconductor integrated circuit including a monitor unit.

2. Description of Related Art

Recently, functions of large-scale integrations (LSIs) have been remarkably enhanced recently. In response to this enhancement, a demand has been made for a method of debugging in software and analyzing operations of hardware efficiently. For example, according to Japanese Patent Application Laid-open Publication No. 2002-24201 (hereinafter referred to as “Patent Document 1”), the debugging efficiency is enhanced by selectively outputting an internal signal of a micro processing unit (MPU) and an internal signal of a peripheral circuit in an LSI.

In conjunction with the execution of a program by an MPU, there is a change in an internal signal of an LSI (for example, an internal signal of the peripheral circuit). For the purpose of examining how an internal signal of an LSI changes when the MPU executes an instruction, it is necessary to make clear a corresponding relationship between the executed instruction and the internal signal acquired at that time. In other words, if the executed instruction is not associated with the acquired internal signal, an effort needs to be made, in some cases, for checking, with the acquired internal signal, on what instruction was executed at that time.

In a case where, for instance, an MPU repeatedly executes the same instruction, it may be difficult, in some cases, to examine how many times the instruction has been executed before the one to which an acquired monitor signal corresponds.

In the case shown by Patent Document 1, the execution of an instruction is not synchronized with the acquisition of an internal signal of the LSI. For this reason, the execution of the program by the MPU is not associated with the acquisition of the monitor signal from the peripheral circuit. Accordingly, as described above, it is impossible to efficiently debug the software and to analyze the operations of the hardware on the basis of the acquired monitor signal.

### SUMMARY

As described above, with the conventional art, it is impossible to efficiently debug in software and to analyze the operations of hardware on the basis of an acquired monitor signal.

A semiconductor integrated circuit includes a processor executing a target program to be debugged, a peripheral circuit generating an internal signal in response to an operation of the processor, and a monitor unit storing the internal signal of the peripheral circuit in response to a first status signal from the processor executing the target program.

The monitor unit receives the internal signal in association with the period of time for which the processor is executing the program. This makes it possible to easily associate the executed program with the received signals. Accordingly, it is possible to stop unnecessary signals from being acquired, and thereby to achieve an efficient analysis, for example.

On the basis of the acquired monitor signals, the software can be efficiently debugged, and the operation of the hardware can be efficiently analyzed.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a diagram illustrating an LSI 1 according to a first embodiment.

FIG. 2 is a schematic and explanatory diagram of a debugger.

FIG. 3 is a timing chart illustrating how the LSI 1 operates.

FIG. 4 is a schematic and explanatory diagram of processing which is performed at time t1 in the timing chart shown in FIG. 3.

FIG. 5 is a schematic and explanatory diagram of processing which is performed at time t2 in the timing chart shown in FIG. 3.

FIG. 6 is a schematic and explanatory diagram of processing which is performed at time t4 in the timing chart shown in FIG. 3.

FIG. 7 is a schematic and explanatory diagram of processing which is performed at time t5 in the timing chart shown in FIG. 3.

FIG. 8 is a diagram illustrating an LSI 50 according to a second embodiment.

FIG. 9 is a timing chart illustrating how the LSI 50 operates.

FIG. 10 is a schematic and explanatory diagram of processing which is performed at time t6 in the timing chart shown in FIG. 9.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes. Descriptions will be provided hereinafter for embodiments of the present invention by use of the drawings. It should be noted that the drawings are schematic, and that the drawings shall not be interpreted as narrowing the technical scope of the present invention. In addition, the same components are denoted by the same reference numerals, and duplicated descriptions will be accordingly omitted.

### First Embodiment

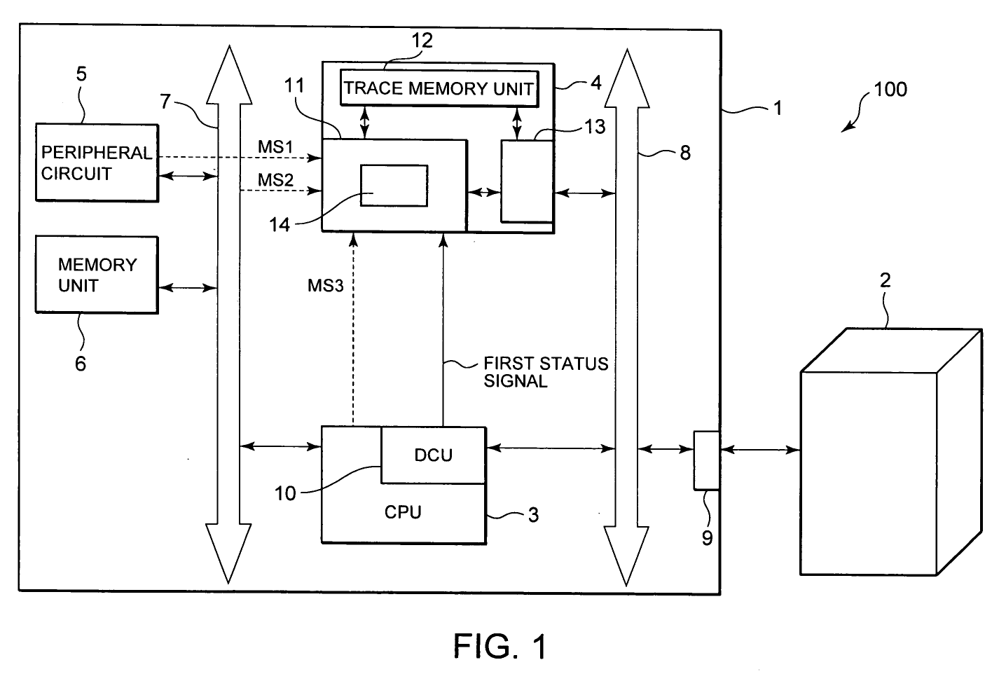

FIG. 1 shows a debugging system 100 including a semiconductor integrated circuit 1 (LSI 1) according to a first embodiment. As shown in FIG. 1, the debugging system 100 includes the LSI 1 and an external computer 2. Software (a debugger) for assisting the finding of a bug in a program is installed in the external computer 2. A person in charge of system development causes the LSI 1 to download a program (a test program) to be a test object by use of the debugger. In addition, by use of the debugger, the person in charge of system development sets up monitor signals to be monitoring objects in the LSI 1, and acquires monitor signals which have been kept in the LSI 1.

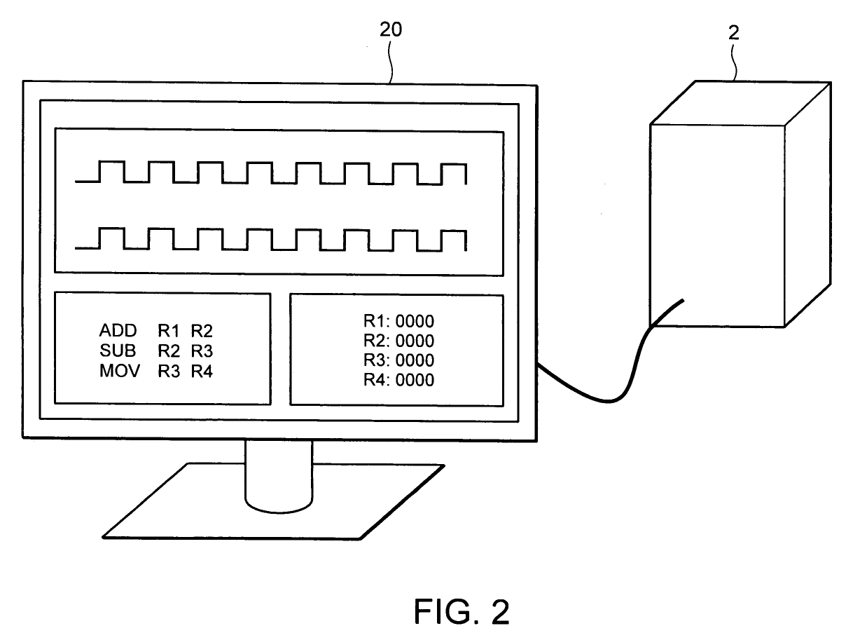

As shown in FIG. 2, a display 20 is connected to the external computer 2. Waveforms (monitor waveforms) based on the respective acquired monitor signals are displayed on the display 20. By use of the monitor waveforms displayed on the display 20, the person in charge of system development finds a bug in the program or analyzes the operation of the LSI 1.

Descriptions will continue by returning to FIG. 1. The LSI 1 includes a central processing unit (CPU) 3, a monitor unit 4, a peripheral circuit 5, a memory unit 6, a system bus 7, a communications bus 8, and a communications port 9.

The external computer 2 is connected to the communications port 9 of the LSI 1. By use of the debugger installed in the external computer 2, a test program is downloaded to the LSI 1. The test program is stored in the memory unit included in the LSI 1.

By use of the debugger, the person in charge of system development beforehand sets up, in a monitor control unit 14 to be described later, information on which internal signals among internal signals of the LSI 1 should be acquired as monitor signals. In this case, an internal signal given from the peripheral circuit 5 is set as a monitor signal MS1, an internal signal given from the system bus 7 is set as a monitor signal MS2, and an internal signal given from the CPU 3 is set as a monitor signal MS3. It should be noted that the number of internal signals of the LSI 1 to be acquired as monitor signals is arbitrary. The monitor control unit 14 receives each of the internal signals MS1, MS2 and MS3 via not the system bus but signal lines.

The CPU 3 executes the program stored in the memory unit 6 on the basis of a command for the program to be executed, which is given from the debugger. In addition, the CPU 3 stops executing the program stored in the memory unit 6 on the basis of a command for the program to stop being executed, which is given from the debugger. It should be noted that the program stored in the memory unit 6 can be rewritten by the debugger. Accordingly, the CPU 3 executes a program obtained as a result of the debugger's rewrite in some cases.

The CPU 3 includes a program counter (PC), an accumulator and various registers (none of which are illustrated in FIG. 1). The CPU 3 further includes a debug control unit (DCU) 10.

In the case of the present embodiment, the debug control unit 10 detects whether or not the CPU is executing a program. A first status signal which is at a signal level depending on whether or not the CPU 3 is executing the program is then given from debug control unit 10 to the monitor unit 4. Here, the first status signal is a digital signal having two signal levels, a HIGH level and a LOW level.

The monitor unit 4 includes a monitor interface (I/F) 11 (a first interface unit 11), a trace memory unit 12, communications I/F 13 (a second interface unit 13), and a monitor control unit 14.

Internal signals of the LSI 1 are given to the monitor. I/F 11. In this case, the internals signals of the LSI 1 thus given are an internal signal given from the peripheral circuit 5, an internal signal given from the system bus 7, and an internal signal given from the CPU 3. In addition, the first status signal is also given to the monitor I/F 11 from the debug control unit 10.

In accordance with a condition set by the debugger, the monitor control unit 14 makes a control for whether or not the internal signals given to the monitor I/F 11 should be written as monitor signals in the trace memory unit 12. As described above, information on which internal signals among the internal signals given to the monitor I/F 11 should be acquired as the monitor signals (written in the trace memory unit 12) is beforehand set up in the monitor control unit 14 by use of the debugger.

Furthermore, on the basis of the first status signal given to the monitor I/F 11, the monitor control unit 14 makes a control for whether or not monitor signals should be acquired (monitor signals should be written in the trace memory 12) as well.

It should be noted that the monitor I/F 11 is connected to the communications I/F 13 so that the monitor I/F 11 is configured to be capable of communicating with the debugger.

The communications I/F 13 is connected to the monitor I/F 11 and the trance memory unit 12. Moreover, the communications I/F 13 is also connected to the communications bus 8. In other words, the communications I/F 13 constitutes a communications interface between the monitor unit 4 and the debugger. Specifically, the monitor signals stored in the trace memory unit 12 are read out to the communications bus 8 via the communications I/F 13. Subsequently, the monitor signals outputted to the communications bus 8 are read out to the external computer 2 via the communications port 9.

The system bus 7 is a data transmission channel. The CPU 3, the peripheral circuit 5 and the memory unit 6 are connected to the system bus 7. The communications bus 8 is a data transmission channel. The CPU 3, the communications port 9 and the monitor unit 4 are connected to the communications bus 8.

The CPU 3 and the monitor unit 4 included in the LSI 1 are controlled by the common debugger via the common communications port 9. This makes it possible to efficiently find a bug in the program and analyze the operation of the LSI 1.

In the case of the present embodiment, when the CPU 3 starts to execute the program, the debug control unit 10 included in the CPU 3 changes the signal level of the first status signal from the HIGH level to the LOW level. Subsequently, while the CPU 3 is executing the program, the first status signal is kept at the LOW level.

By contrast, when the CPU 3 stops executing the program, the debug control unit 10 changes the signal level of the first status signal from the LOW level to the HIGH level. Afterward, until the CPU 3 resumes executing the program, the first status signal is kept at the HIGH level.

As described above, the first status signal is given from the debug control unit 10 in the CPU 3 to the monitor unit 4. Thereafter, when the debug control unit 10 changes the signal level of the first status signal from the HIGH level to the LOW level, the monitor unit 4 starts to acquire the monitor signals (MS1 to MS3).

Specifically, by changing the signal level of the first status signal from the HIGH level to the LOW level, the debug control unit 10 informs the monitor unit 4 of a timing at which the monitor unit 4 should start to acquire the monitor signals. In other words, the fall of the signal level of the first status signal is a “monitor start signal” for causing the monitor unit 4 to start to acquire the monitor signals.

The “monitor start signal” is given from the debug control unit 10 to the monitor unit 4 when the debug control unit 10 detects the start of executing the program by the CPU 3. Thus, the time when the monitor unit 4 starts to acquire the monitor signals is set virtually equal to the time when the CPU 3 starts to execute the program. It should be noted that the wording “virtually” in this case means that it does not matter if the time when the monitor unit 4 starts to acquire the monitor signals more or less deviates from the internal standard clock of the LSI 1 when the internal standard clock of the LSI 1 is used as a reference clock.

The monitor unit 4 stops acquiring the monitor signals (MS1 to MS3) when the debug control unit 10 in the CPU 3 changes the signal level of the first status signal from the LOW level to the HIGH level.

Specifically, the debug control unit 10 informs, by changing the signal level of the first status signal from the LOW level to the HIGH level, the monitor unit 4 of the timing at which the monitor unit 4 should stop acquiring the monitor signals. In other words, the rise of the signal level of the first status signal is a “monitor stop signal” for causing the monitor unit 4 to stop acquiring the monitor signals.

The “monitor stop signal” is given from the debug control unit 10 to the monitor unit 4 when the debug control unit 10 detects the stop of executing the program by the CPU 3. Thus, the time when the monitor unit 4 should stop acquiring the monitor signals is set virtually equal to the time when the CPU 3 stops executing the program.

It should be noted that the wording “virtually” in this case means that it does not matter if the time when the monitor unit 4 stops acquiring the monitor signals more or less deviates from the internal standard clock of the LSI 1 when the internal standard clock of the LSI 1 is used as the reference clock.

As described above, the debug control unit 10 gives the monitor start signal to the monitor unit 4 in synchronization with the CPU 3's starting to execute the program, and gives the monitor stop signal to the monitor unit 4 in synchronization with the CPU 3's stopping executing the program. The low-level first status signal is given from the debug control unit 10 to the monitor unit 4 after the monitor start signal is given from the debug control unit 10 to the monitor unit 4, and until the monitor stop signal is subsequently given from the debag control unit 10 to the monitor unit 4.

In sum, the debug control unit 10 gives the low-level first status signal (active status signal) to the monitor unit 4 while the CPU 3 is executing the program (during the program executing period). In addition, the debug control unit 10 gives the high-level first status signal (non-active status signal) to the monitor unit 4 while the CPU 3 is executing no program (during the program non-executing period).

The monitor unit 4 acquires the monitor signals while the debug control unit 10 is giving the low-level first status signal to the monitor unit 4. On the other hand, the monitor unit 4 acquires no monitor signals while the debug control unit 10 is giving the high-level first status signal to the monitor unit 4. Accordingly, on the basis of the signal level of the first status signal given to the monitor unit 4 from the debug control unit 10, it is determined whether or not the monitor unit 4 should acquire the monitor signals.

This configuration enables the CPU 3 to simply inform the monitor unit 4 of the time when the CPU 3 has started to execute the program and the time when the CPU 3 has stopped executing the program. Subsequently, the monitor unit 4 starts or stops the operation of acquiring the internal signals of the LSI 1 as the monitor signals.

In addition, this configuration enables the CPU 3 to simply inform the monitor unit 4 of the period for which the CPU 3 is executing the program, and the period for which the CPU 3 is stopping executing the program. Furthermore, the monitor unit 4 acquires the internal signals of the LSI 1 as the monitor signals in association with the period for which the CPU 3 is executing the program, and acquires no internal signals of the LSI 1 as the monitor signals in association with the period for which the CPU 3 is stopping executing the program.

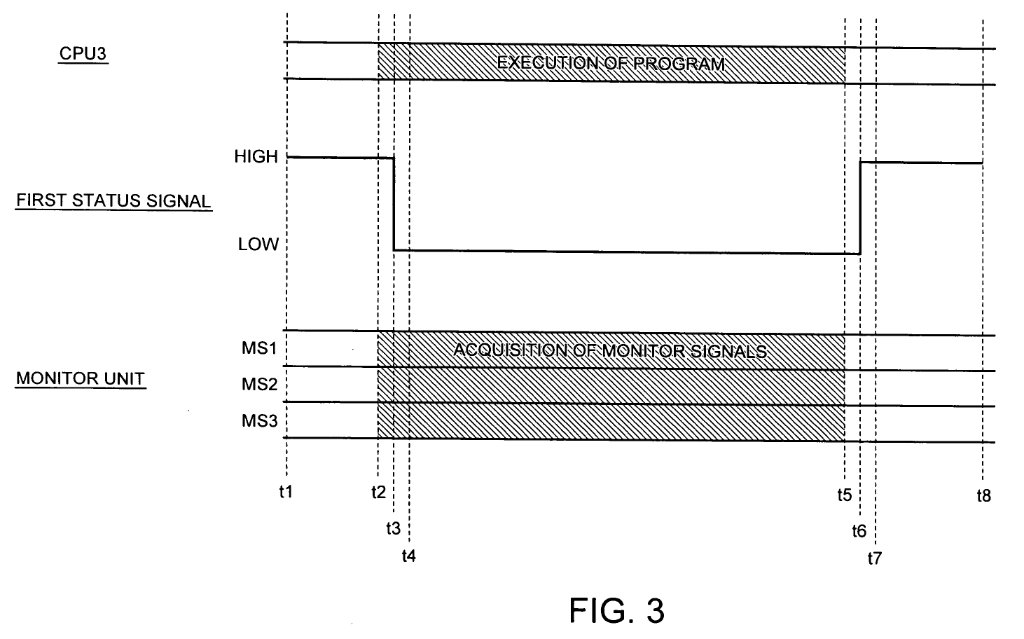

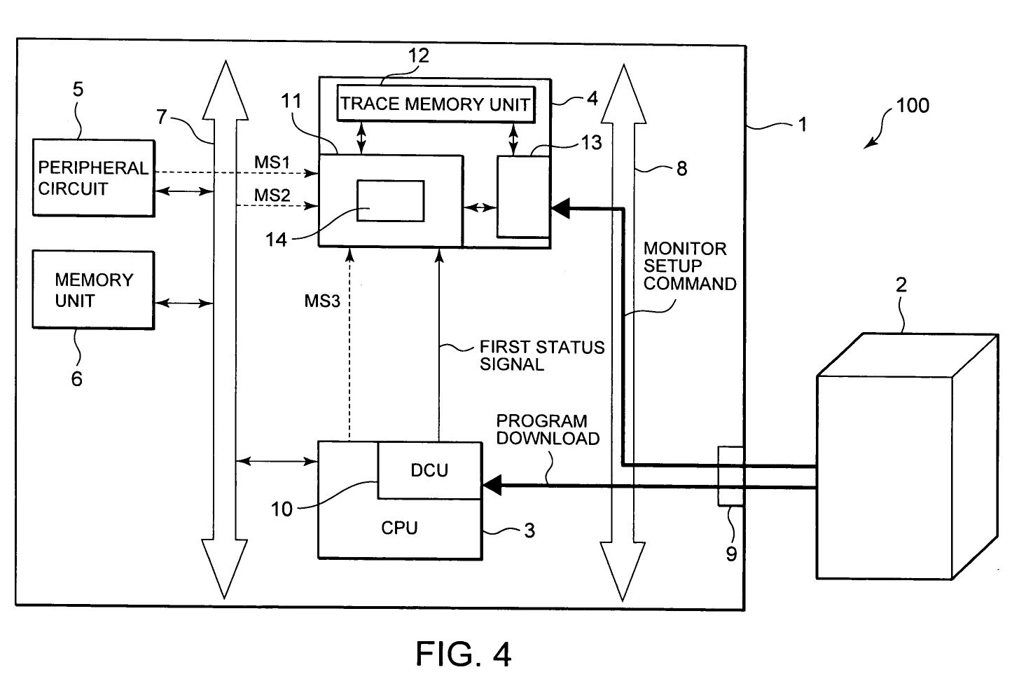

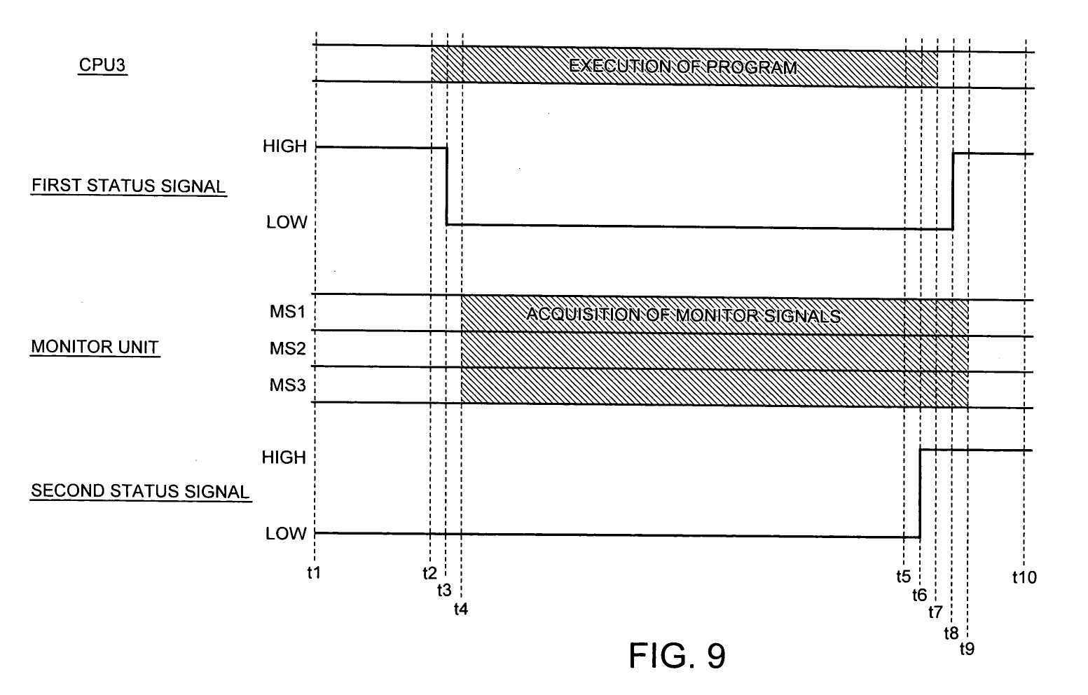

Descriptions will be provided here, by use of a timing chart shown in FIG. 3, for how the LSI 1 according to the present embodiment operates. FIGS. 4 and 9 will also be seen for the descriptions.

At time t1, the “program download,” and the “monitor setup” are performed as shown in FIG. 4. Specifically, the program (test program) as the test object is downloaded from the debugger to the LSI 1. In addition, on the basis of the command (monitor setting command) given from the debugger, the internal signals to be acquired as the monitor signals are set up in the monitor control unit 14. Here, the program is stored in the memory unit 6. At this time, the first status signal is at the HIGH level.

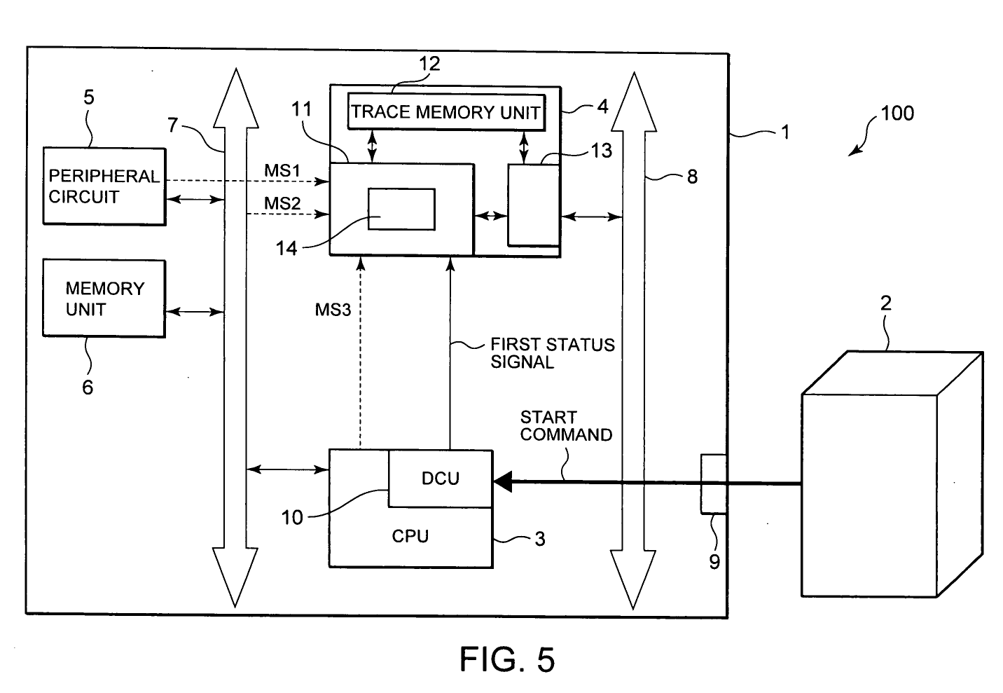

At time t2, the “program execution” is started as shown in FIG. 5. Specifically, the command (start command) for causing the CPU 3 to start to execute the program is given from the debugger to the CPU 3. On the basis of the command from the debugger, the CPU 3 starts to execute the program stored in the memory unit 6. At this time, the first status signal is at the HIGH level.

At time t3, the signal level of the “first status signal” is changed. Specifically, once the debug control unit 10 detects that the CPU 3 has started to execute the program, the debug control unit 10 changes the signal level of the first status signal from the HIGH level to the LOW level. The change of the first status signal from the HIGH level to the LOW level causes the fall of the signal level.

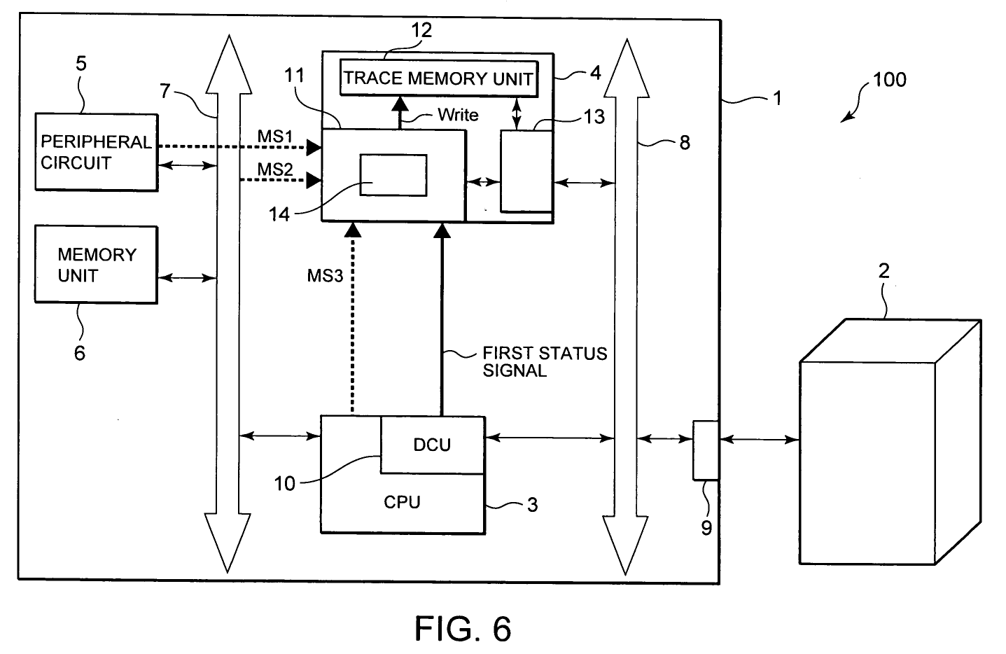

At time t4, the “monitor signal acquisition” is started as shown in FIG. 6. Specifically, once the monitor control unit 14 detects that the signal level of the first status signal has changed from the HIGH level to the LOW level as described above (the fall of the signal level), the monitor control unit 14 starts to acquire the internal signals of the LSI 1, which are specified by the “monitor setup,” as the monitor signals (MS1 to MS3). The internal signals acquired as the monitor signals are written to the trace memory unit 12 (which is schematically shown by an arrow Write in FIG. 6). Thus, the acquiring of the monitor signals is equivalent to the writing of the internal signals to the trace memory unit 12.

In the case of the present embodiment, as described above, the internal signals to be acquired as the monitor signals are set up as follows. Specifically, as explicitly shown in FIG. 6, the monitor unit 4 acquires the internal signal of the peripheral circuit 5 as the monitor signal MS1, the internal signal of the system bus 7 as the monitor signal MS2, and the internal signal of the CPU 3 as the monitor signal MS3. The monitor signals MS1 to MS3 to be inputted to the monitor I/F 11 are written to the trace memory unit 12 as shown by the arrow Write.

It should be noted that time t2 and time t3 are virtually the same timings. Specifically, the signal level of the “first status signal” is changed at virtually the same timing as the “program execution” starts. In addition, time t4 is virtually the same timing as time t3. Specifically, the “monitor signal acquisition” is started at virtually the same timing as the signal level of the “first status signal” is changed. Accordingly, the time when the “program execution” is started and the time when the “monitor signal acquisition” is started are virtually the same timings.

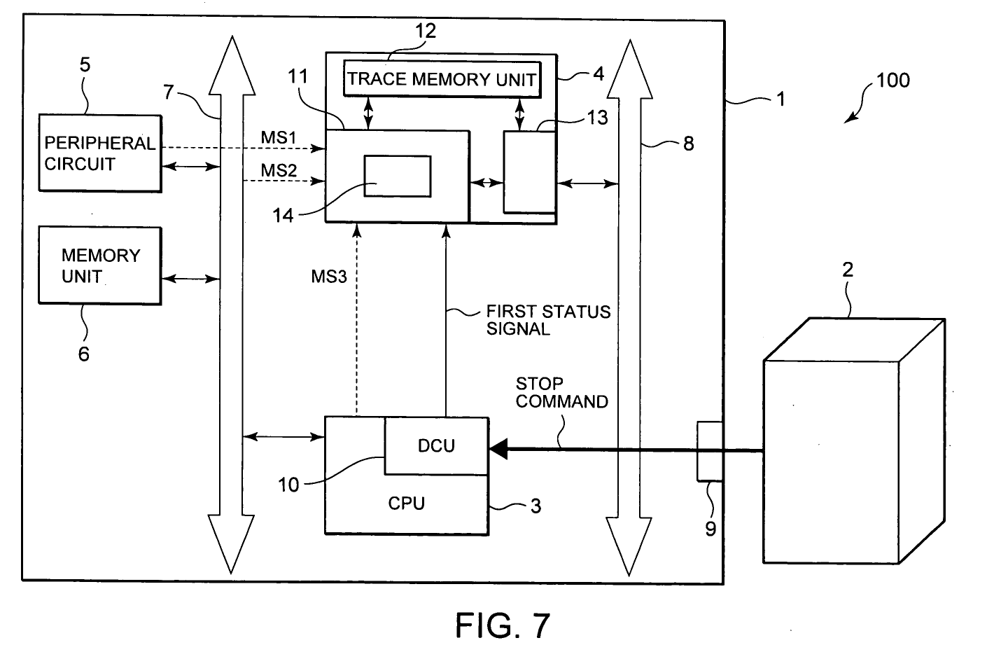

At time t5, the “program execution” is stopped as shown in FIG. 7. Specifically, the command (stop command) for causing the CPU 3 to stop executing the program is given from the debugger to the CPU 3. According to the instruction from the debugger, the CPU 3 stops executing the program.

At time t6, the signal level of the first status signal is changed. Specifically, once the debug control unit 10 detects that the CPU 3 has stopped executing the program, the debug control unit 10 changes the signal level of the first status signal from the LOW level to the HIGH level.

At time t7, the “monitor signal acquisition” is stopped. Specifically, once the monitor control unit 14 detects that the signal level of the firststatus signal has changed from the LOW level to the HIGH level (the rise of the signal level), the monitor control unit 14 stops acquiring the internal signals of the LSI 1 as the monitor signals.

It should be noted that time t6 and time t5 are virtually the same timings. In addition, time 7 and time 6 are virtually the same timings. Specifically, the timing at which the “program execution” is stopped and the timing at which the signal level of the “first status signal” is changed are virtually the same timings. In addition, the timing at which the signal level of the “first status signal” is changed and the timing at which the “program execution” is stopped are virtually the same timings. Accordingly, the timing at which the “program execution” is stopped and the timing at which the “monitor signal acquisition” is stopped are virtually the same timings.

At time t8, the “monitor signal readout” is performed. Specifically, a command (read command) for reading out the signals accumulated in the monitor unit 4 is given to the monitor unit 4 whereas a command (read command) for reading out the signals accumulated in the CPU 3 is given to the CPU 3. Subsequently, the monitor signal stored in the trace memory unit 12 of the monitor unit 4 and the signals stored respectively in various registers included in the CPU 3 are read to the external computer 2. Afterward, through the processing by the debugger, waveforms respectively of the monitor signals are displayed on the display 20 connected to the external computer 2.

As is clear from the foregoing description, the debug control unit 10 changes the signal level of the first status signal from the HIGH level to the LOW level when the CPU 3 starts to execute the program. Specifically, the debug control unit 10 informs the monitor control unit 14 that the CPU 3 starts to execute the program by changing the signal levels the first status signal.

On the basis of the fall of the signal level of the first status signal (the monitor start signal), which is given from the debug control unit 10 of the CPU 3, the monitor control unit 14 of the monitor unit 4 detects that the CPU 3 has started to execute the program. Subsequently, the monitor control unit 14 starts the operation of acquiring the internal signals of the LSI 1 as the monitor signals.

In addition, as is clear from the foregoing description, the debug control unit 10 changes the signal level of the first status signal from the LOW level to the HIGH level, when the CPU 3 stops executing the program. Specifically, the debug control unit 10 informs the monitor control unit 14 that the CPU 3 has stopped executing the program by changing the signal levels of the first status signal.

On the basis of the rise of the signal level of the first status signal (the monitor stop signal), which is given from the debug control unit 10 of the CPU 3, the monitor control unit 14 of the monitor unit 4 detects that the CPU 3 has stopped executing the program. Afterward, the monitor control unit 14 stops the operation of acquiring the internal signals of the LSI 1 as the monitor signals.

Moreover, as is clear from the foregoing description, the debug control unit 10 keeps the first status signal at the LOW level in association with the period for which the CPU 3 is executing the program. In addition, the debug control unit 10 keeps the first status signal at the HIGH level in association with the period for which the CPU 3 is stopping executing the program. Consequently, the monitor unit 4 acquires the monitor signals (continues the operation of acquiring the monitor signals) while the signal level of the first status signal is at the LOW level (the first signal level), and acquires no monitor signals (continues the operation of acquiring no monitor signals) while the signal level of the first status signal is at the HIGH level (the second signal level).

In some case, the CPU 3 concurrently executes a program (for example, a debug assisting program) different from the test program while executing the test program. For this reason, it is likely that the monitor unit 4 acquires internal signals, which are generated due to the execution of the different program, as the monitor signals. If the monitor unit 4 acquires unnecessary internal signals as the monitor signals, this acquisition obstructs the test program from being efficiently debugged, and obstructs the operation of the LSI 1 from being efficiently analyzed.

In the case of the present embodiment, as described above, the monitor unit 4 acquires the internal signals of the LSI 1 as the monitor signals while the CPU 3 is executing the program. As a result, the monitor 4 is checked from acquiring monitor signals unnecessary for the program analysis. This enables the program to be efficiently debugged, and concurrently enables the operation of the hardware to be efficiently analyzed.

### Second Embodiment

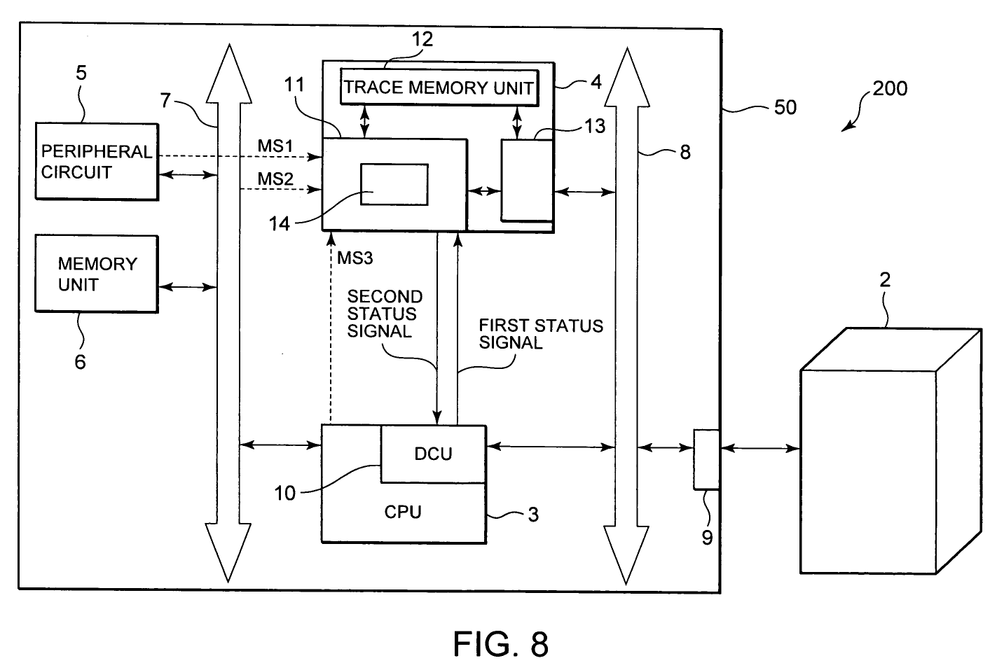

FIG. 8 shows a debug system 200 including a semiconductor integrated circuit 50 (an LSI 50) according to a second embodiment. It should be noted that the duplicated descriptions will be omitted as mentioned at the beginning.

What makes the second embodiment different from the first embodiment is that a second status signal is given from the monitor unit 4 to the CPU 3. Like the first status signal, the second status signal is a digital signal having the two signal levels, the HIGH level and the LOW level.

The monitor control unit 14 gives a break signal to the debug control unit 10 by changing the signal levels of the second status signal when a certain one of the acquired monitor signals satisfies a trigger condition which is set up beforehand. Subsequently, the CPU 3 stops executing the program upon reception of the break signal. It should be noted that the trigger condition is beforehand set up in the monitor control unit 14 by the debugger before the CPU 3 starts to execute the program.

Descriptions will be provided hereinafter for what makes the second embodiment different from the first embodiment on the basis of a timing chart shown in FIG. 9.

At time t1, the “program download” and the “monitor setup” are performed as in the case of the first embodiment. In addition, the “trigger condition setup” is also performed in the case of the second embodiment. Specifically, a predetermined command is given from the debugger to the monitor control unit 14, and thereby the trigger condition is set up in the monitor control unit 14. For instance, a rise of the signal level of one of the monitor signals, which changes from the LOW level to the HIGH level, may be set up as the trigger condition. At time t1, the second status signal is at the LOW level.

At time t2, the “program execution” is started as in the case of the first embodiment. Subsequently, at time t3, the signal level of the “status signal” is changed as in the case of the first embodiment. At time t4, the “monitor signal acquisition” is started as in the case of the first embodiment. As in the case of the first embodiment, time t3 and time t2 are virtually the same timings, and time t4 and time t3 are virtually the same timings. Thus, the timing at which the “program execution” is started and the timing at which the “monitor signal acquisition” is started are virtually the same timings. In the two cases, the signal level of the second status signal is the LOW level.

In the case of the present embodiment, the “trigger condition” is satisfied at time t5. Specifically, the monitor control unit 14 detects that the acquired monitor signal satisfies the trigger condition set up beforehand.

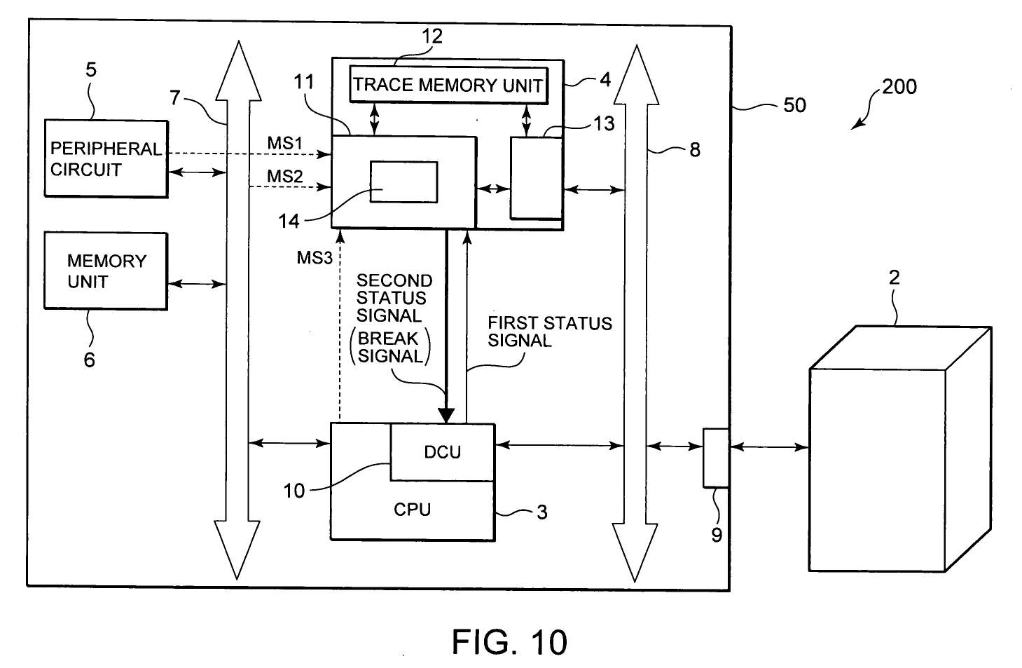

In the case of the present embodiment, the signal level of the “second status signal” is then changed at time t6. Specifically, the monitor control unit 14 changes the signal level of the second status signal from the LOW level to the HIGH level once the monitor control unit 14 detects that the acquired monitor signal satisfies the trigger condition. The monitor control unit 14 informs, by changing the signal level of the second status signal from the LOW level to the HIGH level, the debug control unit 10 of the CPU 3 that the acquired monitor signal satisfies the trigger condition. In other words, the rise of the signal level of the second status signal (the change in the signal level) is a signal (break signal) for the CPU 3 to stop executing the program. FIG. 10 schematically shows the break signal given from the monitor control unit 14 to the debug control unit 10.

At time t7, the “program execution” is stopped. Specifically, the debug control unit 10 controls the CPU 3 in order that the CPU 3 can stop executing the program, once the debug control unit 10 detects that the signal level of the second status signal has changed from the LOW level to the HIGH level (that the debug control unit 10 has received the break signal). Subsequently, the CPU 3 stops executing the program.

At time t8, the signal level of the “first status signal” is changed, as in the case of the first embodiment. Specifically, the debug control unit 10 changes the signal level of the first status signal from the LOW level to the HIGH level once the debug control unit 10 detects that the CPU 3 has stopped executing the program.

At time t9, the “monitor signal acquisition” is stopped as in the case of the first embodiment. Specifically, the monitor control unit 14 stops acquiring the internals signals of the LSI 1 as the monitor signals once the monitor control unit 14 detects that the signal level of the first status signal has changed from the LOW level to the HIGH level (the rise of the signal level).

It should be noted that time t6 and time t5 are virtually the same timings. In other words, the timing at which the “trigger condition” is satisfied and the timing at which the “second status signal” is changed are virtually the same timings. In addition, time t7 and time t6 are virtually the same timings. Thus, the timing at which the signal level of the “second status signal” is changed and the timing at which the “program execution” is stopped are virtually the same timings.

Furthermore, time t8 and time t7 are virtually the same timings. In other words, the timing at which the signal level of the “first status signal” is changed and the timing at which the “program execution” is stopped are virtually the same timings. Similarly, time t9 and time t8 are virtually the same timings. In other words, the timing at which the “monitor signal acquisition” is stopped and the timing at which the signal level of the “first status signal” is changed are virtually the same timings. Accordingly, the timing at which the “program execution” is stopped and the timing at which the “monitor signal acquisition” is stopped are virtually the same timings.

At time t10, the “signal readout” is performed as in the case of the first embodiment. Specifically, a command (read command) for reading the signals accumulated in the monitor unit 4 is given to the monitor unit 4 whereas a command (read command) for reading the signals accumulated in the CPU 3 is given to the CPU 3. Thereby, the monitor signals accumulated in the trace memory unit 12 in the monitor unit 4 and the signals accumulated in various registers included in the CPU 3 are read to the external computer 2. Thereafter, through the processing by the debugger, waveforms respectively of the monitor signals are displayed on the display 20 connected to the external computer 2.

As is clear from the foregoing descriptions, the monitor control unit 14 changes the signal level of the second status signal from the LOW level to the HIGH level when a certain one of the acquired monitor signals satisfies the trigger condition. Specifically, the monitor control unit 14 informs the debug control unit 10 that the monitor signal satisfies the trigger condition by changing the signal level of the second status signal.

On the basis of the rise of the signal level of the second status signal given from the monitor control unit 14 of the monitor unit 4, the debug control unit 10 of the CPU 3 causes the CPU 3 to stop executing the program. As described above, the rise of the signal level of the second status signal (the change in the signal level) is the break signal for causing the CPU 3 to stop executing the program.

In the case of the present embodiment, as described above, the CPU 3 stops executing the program in synchronization with the timing at which the monitor signal satisfies the trigger condition. Afterward, the monitor unit 4 stops the operation of acquiring the internal signals of the LSI 1 as the monitor signals in synchronization with the timing at which the CPU 3 stops executing the program. This accordingly makes it possible to stop executing the program and acquiring the monitor signals in accordance with the change in the acquired monitor signal. This enables the operation of the hardware to be efficiently analyzed.

The technical scope of the present invention is not limited to the foregoing embodiments. For example, the monitor start signal and the monitor stop signal may be command signals each represented by two or more bits. Similarly, the break signal may be a command signal represented by two or more bits as well.

In addition, it goes without saying that, unlike in the foregoing embodiments, the LSI need not be configured of a single CPU, or that the LSI may be configured of multiple CPUs.

It is apparent that the present invention is not limited to the above embodiments, but may be modified and changed without departing from the scope and spirit of the invention.

What is claimed is:

1. A semiconductor integrated circuit comprising:
a processor executing a target program to be debugged
a peripheral circuit generating an internal signal in response to an operation of the processor; and
a monitor unit storing the internal signal of the peripheral circuit in response to a first status signal from the processor executing the target program.

2. The semiconductor integrated circuit according to claim 1, wherein
the monitor unit starts and ceases to store the internal signal at a timing responsive to the first status signal.

3. The semiconductor integrated circuit according to claim 2, wherein
the monitor unit stores the internal signal in parallel with the processor executing the target program.

4. The semiconductor integrated circuit according to claim 2, wherein
the first status signal indicates whether the processor is executing the target program or not.

5. The semiconductor integrated circuit according to claim 2, wherein
the monitor unit outputs the stored internal signal to an external device when the processor finishes executing the target program.

6. The semiconductor integrated circuit according to claim 2, wherein
the monitor unit outputs a second status signal indicating whether the internal signal satisfies a predetermined requirement or not, and
the processor receives the second status signal and ceases executing the target program when the second status signal indicates that the internal signal satisfies the predetermined requirement.

7. The semiconductor integrated circuit according to claim 2, wherein
the monitor unit includes
a trace memory storing the internal signal to be stored, and
a first interface unit receiving the internal signal from the peripheral circuit and transferring the internal signal to the trace memory.

8. The semiconductor integrated circuit according to claim 7, wherein
the monitor unit further includes
a second interface unit outputs the internal signal stored in the trace memory to an external device.

9. The semiconductor integrated circuit according to claim 6, wherein
the monitor unit includes
a first interface unit receiving the internal signal,
a trace memory storing the internal signal, and
a monitor control unit making the first interface unit transfer the internal signal to the trace memory and outputting the second status signal to the processor when the internal signal satisfies the predetermined requirement.

10. The semiconductor integrated circuit according to claim 2, wherein
the processor includes
a debug controller outputting the first status signal to the monitor unit in response to the executing of the target program by the processor.

11. A semiconductor integrated circuit comprising:
a processor executing a target program and activating a first status signal in response to a start of an execution of the target program; and
a monitor unit monitoring a first internal signal of a target circuit during the first status signal is activating.

12. The semiconductor integrated circuit according to claim 11, wherein
the processor inactivates the first status signal in response to an end of the execution of the target program.

13. The semiconductor integrated circuit according to claim 11, wherein
the monitor unit includes a memory storing the first internal signal monitored by the monitor unit.

14. The semiconductor integrated circuit according to claim 11, wherein
the monitor unit further monitoring a second internal signal on a bus connected to the target circuit.

15. The semiconductor integrated circuit according to claim 11, wherein
the monitor unit further monitoring a third internal signal of the processor.

16. A semiconductor integrated circuit comprising:
a processor;
a peripheral circuit;
a bus coupled to the processor and the peripheral circuit in a normal mode of operation; and
a monitor unit connected to the processor, the peripheral circuit, and the bus in a debug mode of operation, wherein the processor executes a target program to be debugged, the peripheral circuit generates an internal signal in response to an operation of the processor, and the monitor unit stores the internal signal of the peripheral circuit in response to a first status signal from the processor executing the target program.

17. The semiconductor integrated circuit according to claim 16, wherein
the processor and the peripheral circuit are connected to the monitor unit via not the bus but signal lines respectively in the debug mode of the operation.

18. The semiconductor integrated circuit according to claim 16, wherein
the monitor unit starts and ceases to store the internal signal at a timing responsive to the first status signal.

19. The semiconductor integrated circuit according to claim 18, wherein
the monitor unit stores the internal signal in parallel with the processor executing the target program.

20. The semiconductor integrated circuit according to claim 18, wherein
the first status signal indicates whether the processor is executing the target program or not.
